(19) United States
(12) Patent Application Publication
(10) Pub. No.: US 2015/0281806 A1
(43) Pub. Date: Oct. 1, 2015

(54) RELAY SWITCHING CIRCUIT

(71) Applicant: HON HAI PRECISION INDUSTRY CO., LTD., New Taipei (TW)

(72) Inventor: CHIH-CHENG HUANG, New Taipei (TW)

(21) Appl. No.: 14/481,668

(22) Filed: Sep. 9, 2014

(30) Foreign Application Priority Data
Mar. 25, 2014 (TW) 103111092

(51) Int. Cl. H04Q 3/00; H04L 12/931

(52) U.S. Cl. CPC H04Q 3/0008; H04L 49/35

(57) ABSTRACT

A relay switching circuit to route outgoing telephone calls between a VoIP and a landline and with a surge voltage protection includes a first relay, a second relay, a first control circuit, and a second control circuit. The first relay connects with a foreign exchange station (FXS) port and an FXS circuit to control a connection between the FXS port and the FXS circuit. The second relay connects with the first relay and a foreign exchange office (FXO) port to control a connection between the first relay and the FXO port. The first control circuit connects with a controller to control the first relay. The second control circuit connects with the controller to control the second relay.

### FIELD

The disclosure relates to electronic circuits, and particularly to a relay switching circuit.

### BACKGROUND

A VoIP (Voice over Internet Protocol) is a mode of making a call through an internet protocol. A single relay can be used as a switching circuit in most VoIP products. When the product is working normally, the relay switches a calling line to an FXS (Foreign Exchange Station) and users can make a call through the VoIP or through a PSTN (Public Switched Telephone Network). When a power supply is shut down, the relay switches the calling line to the PSTN route and users are restricted to making a call through the PSTN only.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments.

FIG. 1 is a diagrammatic view of one embodiment of a relay switching circuit used in an application environment.

FIG. 2 is a connection diagram of one embodiment of a relay switching circuit.

FIG. 3 is a connection diagram of another embodiment of a relay switching circuit.

FIG. 4 is a connection diagram of another embodiment of a relay switching circuit.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

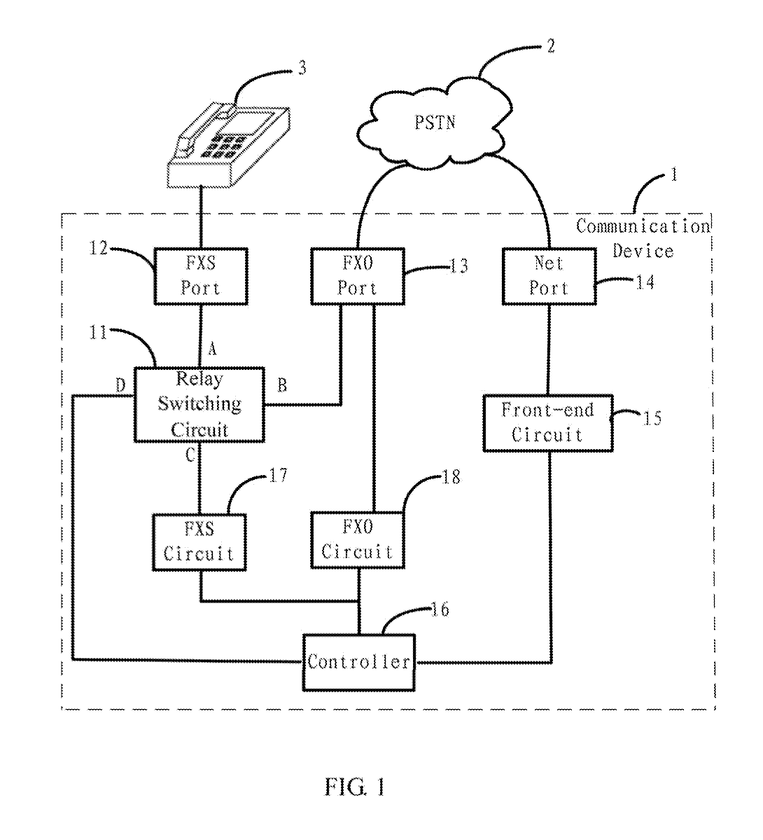

FIG. 1 is a diagrammatic view of one embodiment of a relay switching circuit used in an application environment. When users make a call, communication devices transmit signals through circuits and networks as shown in FIG. 1. The circuits and networks normally include a communication device 1, a Public Switched Telephone Network (PSTN) 2, and user telephone. The communication device 1 includes a relay switching circuit 11, a Foreign Exchange Station (FXS) port 12, a Foreign Exchange Office (FXO) port 13, a net port 14, a front-end circuit 15, a controller 16, an FXS circuit 17, and an FXO circuit 18. The relay switching circuit 11 is used to switch between calling lines and may be protected against lightning strikes. The FXS port 12 is used to connect a telephone 3. The FXO port 13 and the net port 14 are used to connect to the PSTN 2. The front-end circuit 15 connected between the net port 14 and the controller 16 is used to process network signals. The FXS circuit 17 is used to process analog signals. The FXO circuit 18 is used to process and transmit signals to the FXO port 13. The controller 16 connected between the FXS circuit 17 and the FXO circuit 18 and the relay switching circuit 11 is used to provide an enable signal to the relay switching circuit 11. According to different working statuses, the front-end circuit 15, the controller 16, the FXS circuit 17, and the FXO circuit 18 work in different modes. When lightning strikes an object connected to the PSTN 2, and surge voltages are created, the relay switching circuit 11 protects circuits of the communication device 1 from being compromised.

In at least one embodiment, a port A of the relay switching circuit 11 connects to telephone 3 through the FXS port 12, a port B of the relay switching circuit 11 connects to the PSTN 2 through the FXO port 13, and a port C of the relay switching circuit 11 connects to outside networks through circuits and components. The sequence of connections between the relay switching circuit 11 and the PSTN 2 is through the FXS circuit 17, the controller 16, the front-end circuit 15, and the net port 14. In addition, a port D of the relay switching circuit 11 connects to the controller 16 to control the enable signal of the calling line. One end of the FXO circuit 18 connects to the FXO port 13, another end of the FXO circuit 18 connects to the FXS circuit 17 and the controller 16. In other embodiments, the net port 14 can also connect to other networks.

When the communication device 1 is working normally, the relay switching circuit 11 receives the enable signal, thus the relay switching circuit 11 connects to the FXS circuit 17 through the port C and switches off the outside connection of the port B, so that users can make a call using Voice over Internet Protocol (VoIP) or a PSTN 2. When a power supply to the communication device 1 is shut off, the relay switching circuit 11 cannot receive the enable signal, thus the relay switching circuit 11 connects to the FXO port 13 through the port B and switches off the outside connection of the port C, so users can only make a call through the PSTN 2.

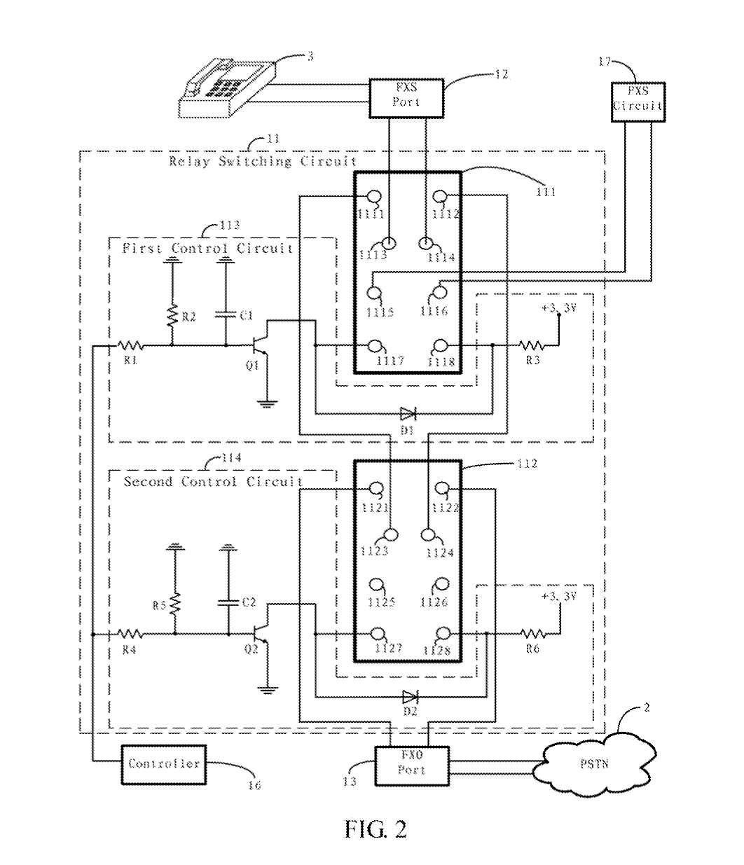

FIG. 2 is a connection diagram of one embodiment of a relay switching circuit 11. As shown in FIG. 2, the relay switching circuit 11 includes a first switching circuit 111, a second switching circuit 112, a first control circuit 113, and a second control circuit 114. The first switching circuit 111 connects to the FXS port 12 and the FXS circuit 17 to control the connection between the FXS port 12 and the FXS circuit 17. The second switching circuit 112 connects to the first switching circuit 111 and the FXO port 13 to control the connection between the first switching circuit 111 and the FXO port 13. The first control circuit 113 is used to receive the enable signal from the controller 16 to control the first switching circuit 111, and the second control circuit 114 is used to receive the enable signal from the controller 16 to control the second switching circuit 112.

The first switching circuit 111 includes a first normally closed contact 1111, a second normally closed contact 1112, a first common contact 1113, a second common contact 1114, a first normally open contact 1115, a second normally open contact 1116, a first control terminal 1117, and a second control terminal 1118. The first common contact 1113 and the second common contact 1114 connect to the FXS port 12 and the first normally open contact 1115 and the second normally open contact 1116 connect to the FXS circuit 17.

The second switching circuit 112 includes a third normally closed contact 1121, a fourth normally closed contact 1122, a third common contact 1123, a fourth common contact 1124, a third normally open contact 1125, a fourth normally open contact 1126, a third control terminal 1127, and a fourth control terminal 1128. The third normally closed contact 1121 and the fourth normally closed contact 1122 connect to the FXO port 13 and the third common contact 1123 connects to the first normally closed contact 1111. The fourth common contact 1124 connects to the second normally closed contact 1112. Neither the third normally open contact 1125 nor the fourth normally open contact 1126 are connected to circuits outside of the second switching circuit 112.

In at least one embodiment, the relays used are double pole double throw (DPDT) switches. In other embodiments, other kinds of relays can be used in the relay switching circuit 11, such as single pole double throw (SPDT) relays or single pole single throw (SPST) relays. When the first switching circuit 111 is not working, the first common contact 1113 connects to the first normally closed contact 1111 and the second common contact 1114 connects to the second normally closed contact 1112. When the second switching circuit 112 is not working, the third common contact 1123 connects to the third normally closed contact 1121 and the fourth common contact 1124 connects to the fourth normally closed contact 1122. When the first switching circuit 111 is working, the first common contact 1113 switches off the connection to the first normally closed contact 1111 and connects to the first normally open contact 1115 and the second common contact 1114 switches off the connection to the second normally closed contact 1112 and connects to the second normally open contact 1116. When the second switching circuit 112 is working, the third common contact 1123 switches off the connection to the third normally closed contact 1121 and connects to the third normally open contact 1125 and the fourth common contact 1124 switches off the connection to the fourth normally closed contact 1122 and connects to the fourth normally open contact 1126.

The first control circuit 113 includes a first resistor R1, a second resistor R2, a third resistor R3, a first capacitor C1, a first switching component Q1, and a first diode D1. A first end of the first resistor R1 connects to the controller 16, a second end of the first resistor R1 connects to one end of the second resistor R2 and to one end of the first capacitor C1. The other end of the second resistor R2 connects to a ground, the other end of the first capacitor C1 is also connected to the ground. The first switching component Q1 is used to control the first control circuit 113 to turn on or turn off. A first electrode of the first switching component Q1 connects to the second end of the first resistor R1, a second electrode of the first switching component Q1 connects to a positive electrode of the first diode D1, and a third electrode of the first switching component Q1 is also connected to the ground. The positive electrode of the first diode D1 also connects to the first control terminal 1117 of the first switching circuit 111. A negative electrode of the first diode D1 connects to the second control terminal 1118 of the first switching circuit 111 and one end of the third resistor R3, the other end of the third resistor R3 connects to a power supply. The first diode D1 is used to provide a discharge circuit for the first control terminal 1117 and the second control terminal 1118 of the first switching circuit 111.

The second control circuit 114 includes a fourth resistor R4, a fifth resistor R5, a the sixth resistor R6, a second capacitor C2, a second switching component Q2, and a second diode D2. A first end of the fourth resistor R4 connects to the controller 16, a second end of the fourth resistor R4 connects to one end of the fifth resistor R5 and one end of the second capacitor C2. The other end of the fifth resistor R5 connects to a ground, the other end of the second capacitor C2 is also connected to the ground. The second switching component Q2 is used to control the second control circuit 114 to turn on or turn off. A first electrode of the second switching component Q2 connects to the second end of the fourth resistor R4, a second electrode of the second switching component Q2 connects to a positive electrode of the second diode D2, and a third electrode of the second switching component Q2 also connects to the ground. The positive electrode of the second diode D2 also connects to the third control terminal 1127 of the second switching circuit 112. A negative electrode of the second diode D2 connects to the fourth control terminal 1128 of the second switching circuit 112 and to one end of the sixth resistor R6, the other end of the sixth resistor R6 connects to the power supply. The second diode D2 is used to provide a discharge circuit for the third control terminal 1127 and the fourth control terminal 1128 of the second switching circuit 112.

In at least one embodiment, the first switching component Q1 and the second switching component Q2 are NPN type transistors. The first electrodes of the first switching component Q1 and of the second switching component Q2 are the base terminals of transistors, the second electrodes of the first switching component Q1 and of the second switching component Q2 are the collector terminals of transistors, and the third electrodes of the first switching component Q1 and of the second switching component Q2 are the emitter terminals of transistors. In other embodiments, other switching components can be used to build control circuits, such as Metal-Oxide-Semiconductor Field-Effect-Transistors (MOSFETs).

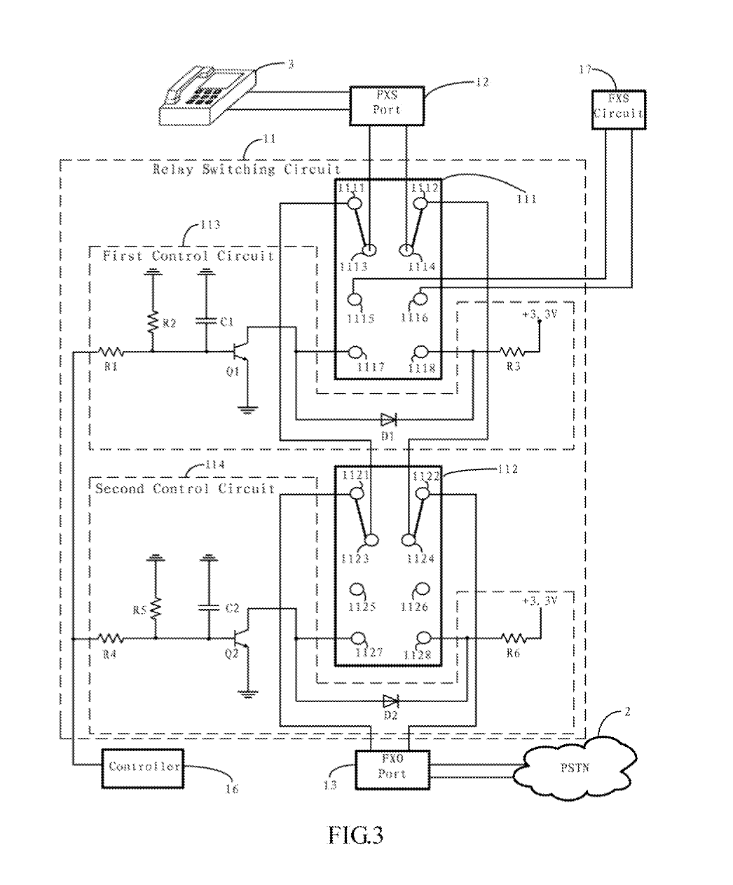

FIG. 3 is a connection diagram of one embodiment of a relay switching circuit 11 when a power supply to the communication device 1 is shut off. As shown in FIG. 3, in at least one embodiment, the controller 16 does not send an enable signal, and the first switching component Q1 and the second switching component Q2 are not working, thus there is no current in the first control circuit 113 and the second control circuit 114. When the first switching circuit 111 and the second switching circuit 112 are not working, the first common contact 1113 connects to the first normally closed contact 1111, the second common contact 1114 connects to the second normally closed contact 1112, the third common contact 1123 connects to the third normally closed contact 1121, the fourth common contact 1124 connects to the fourth normally closed contact 1122. so that the telephone 3 connects to the PSTN 2 through the relay switching circuit 11 and the FXO port 13.

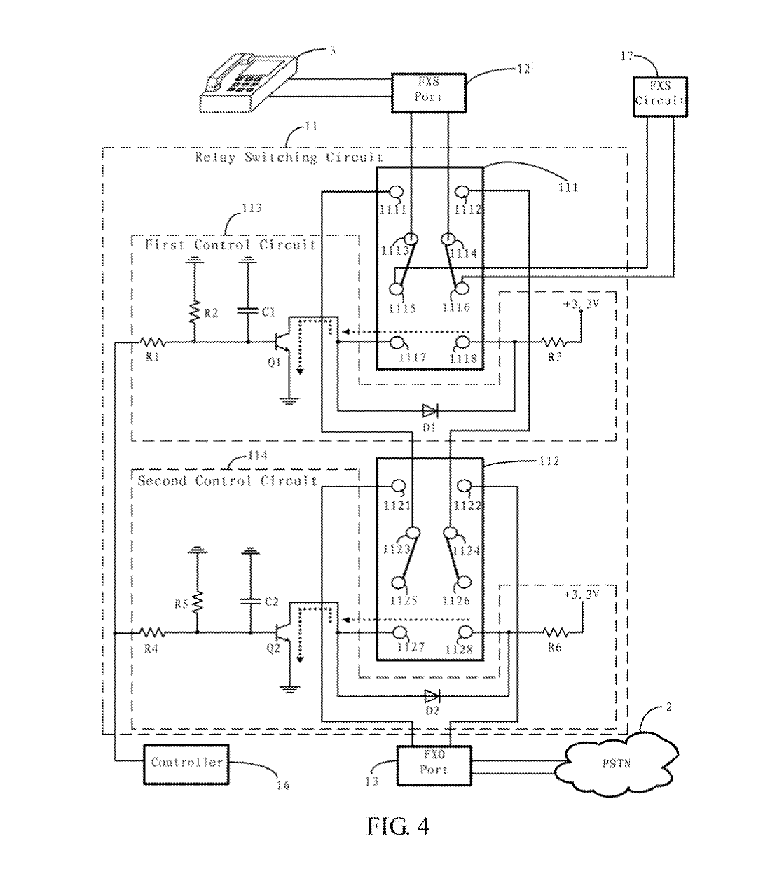

FIG. 4 is a connection diagram of one embodiment of a relay switching circuit 11 when the communication device 1 is working normally. As shown in FIG. 4, in at least one embodiment, the controller 16 sends the enable signal to the first control circuit 113 and to the second control circuit 114. The first switching component Q1 and the second switching component Q2 are working, thus there is current flowing in the first control circuit 113 and the second control circuit 114, as shown by dashed arrows in FIG. 4. The first control terminal 1117 and the second control terminal 1118 are conducting inside the first switching circuit 111. The third control terminal 1127 and the fourth control terminal 1128 are conducting inside the first switching circuit 112. The first switching circuit 111 and the second switching circuit 112 work, so that the telephone 3 connects to the FXS circuit 17 through the first switching circuit 111. Users can thus make a call through the VoIP or through the PSTN.

In at least one embodiment, the relays utilized meet the following specification able to withstand a surge strength between adjacent contacts or between open contacts of 2500 volts in 0.2 microseconds. In other embodiments, relays meeting other standards of proof against surges can also be used in the relay switching circuit 11.

The relay switching circuit 11 above can withstand voltage surges from lightning strikes. As shown in FIG. 4, when the communication device 1 is working normally, the first normally closed contact 1111 does not connect to the first common contact 1113. The first normally closed contact 1111 and the first common contact 1113 can resist a voltage surge between them of 2500 volts in 0.2 microseconds. The third normally closed contact 1121 does not connect to the third common contact 1123, and they do not become conductive in spite of a surge strength between them of 2500 volts in 0.2 microseconds. Since the first normally closed contact 1111 connects to the third common contact 1123, an anti-surge capability between the first normally closed contact 1111 and the third normally closed contact 1121 is 2500 volts in 0.2 microseconds. Therefore, an anti-surge capability between the third normally closed contact 1121 and the first common contact 1113 is 5000 volts in 0.2 microseconds. In the same way, an anti-surge capability between the fourth normally closed contact 1122 and the second common contact 1114 is also 5000 volts in 0.2 microseconds.

If the PSTN 2 is hit by lightning, surge voltages arise against the communication device 1, but the relay switching circuit 11 protects circuits of the communication device 1 with anti-surge capabilities of 5000 volts, a conventional switching circuit using a single relay may only have a capability of withstanding a surge of 2500 volts.

According to the manner of connections used in other embodiments of the relay switching circuit 11, three relays or more than three relays can be used to build relay switching circuits with stronger anti-surge capabilities.

The foregoing disclosure of various embodiments has been presented for the purposes of illustration. It is not intended to be exhaustive or to limit the disclosure to the precise forms disclosed. Many variations and modifications of the embodiments described herein will be apparent to one of ordinary skill in the art in the light of the above disclosure. The scope of the disclosure is to be defined only by the claims appended hereto and their equivalents.

What is claimed is:

1. A relay switching circuit comprising:
a first switching circuit, connecting to an FXS port and an FXS circuit to control a connection between the FXS port and the FXS circuit;
a second switching circuit, connecting to the first switching circuit and an FXO port to control a connection between the first switching circuit and the FXO port;
a first control circuit, connecting to a controller to receive an enable signal from the controller to control the first switching circuit; and
a second control circuit, connecting to the controller to receive the enable signal from the controller to control the second switching circuit.

2. The relay switching circuit as claimed in claim 1, wherein the first switching circuit comprises:
a first normally closed contact;
a second normally closed contact;
a first control terminal, connecting to the first control circuit;
a second control terminal, connecting to the first control circuit;
a first common contact, connecting to the FXS port;
a second common contact, connecting to the FXS port;
a first normally open contact, connecting to the FXS circuit; and
a second normally open contact, connecting to the FXS circuit.

3. The relay switching circuit as claimed in claim 2, wherein the first control circuit comprises:
a first resistor with a first end connected to the controller;
a second resistor, wherein one end of the second resistor connects to a second end of the first resistor and the other end of the second resistor connects to a ground;
a first capacitor, wherein one end of the first capacitor connects to a second end of the first resistor and the other end of the first capacitor connects to the ground;
a first switching component, wherein a first electrode of the first switching component connects to the second end of the first resistor, a second electrode of the first switching component connects to the first control terminal, a third electrode of the first switching component connects to the ground;
a first diode, wherein a positive electrode of the first diode connects to a second electrode of the first switching component, a negative electrode of the first diode connects to the second control terminal; and
a third resistor, wherein one end of the third resistor connects to the negative electrode of the first diode, the other end of the third resistor connects to a power supply.

4. The relay switching circuit as claimed in claim 3, wherein the first switching component is an NPN type transistor, the first electrode of the first switching component is a base electrode of the transistor, the second electrode of the first switching component is a collector of the transistor, the third electrode of the first switching component is an emitter of the transistor.

5. The relay switching circuit as claimed in claim 3, wherein the first diode is used to provide a discharge circuit for the first control terminal and the second control terminal of the first switching circuit.

6. The relay switching circuit as claimed in claim 2, wherein the second switching circuit comprises:
a third control terminal, connecting to the second control circuit;
a fourth control terminal, connecting to the second control circuit;
a third normally closed contact, connecting to the FXO port;
a fourth normally closed contact, connecting to the FXO port;
a third common contact, connecting to the first normally closed contact; and
a fourth common contact, connecting to the second normally closed contact.

7. The relay switching circuit as claimed in claim 6, wherein when the first switching circuit and the second switching circuit are not working, the first common contact connects to the first normally closed contact, the second common contact connects to the second normally closed contact, the third common contact connects to the third normally closed contact, the fourth common contact connects to the fourth normally closed contact; and
when the first switching circuit and the second switching circuit are working, the first common contact switches off the connection to the first normally closed contact and connects to the first normally open contact, the second common contact switches off the connection to the second normally closed contact and connects to the second normally open contact, the third common contact switches off the connection to the third normally closed contact and connects to the third normally open contact, the fourth common contact switches off the connection to the fourth normally closed contact and connects to the fourth normally open contact.

8. The relay switching circuit as claimed in claim 6, wherein the second control circuit comprises:
a fourth resistor, wherein a first end of the fourth resistor connects to the controller;
a fifth resistor, wherein one end of the fifth resistor connects to a second end of the fourth resistor and the other end of the fifth resistor connects to the ground;
a second capacitor, wherein one end of the second capacitor connects to a second end of the fourth resistor and the other end of the second capacitor connects to the ground;
a second switching component, wherein a first electrode of the second switching component connects to the second end of the fourth resistor, a second electrode of the second switching component connects to the third control terminal, a third electrode of the second switching component connects to the ground, the second switching component is used to control the second control circuit turning on or turning off;
a second diode, wherein a positive electrode of the second diode connects to a second electrode of the second switching component, a negative electrode of the second diode connects to the fourth control terminal; and
a sixth resistor, wherein one end of the sixth resistor connects to the negative electrode of the second diode, the other end of the sixth resistor connects to the power supply.

9. The relay switching circuit as claimed in claim 8, wherein the second switching component is an NPN type transistor, the first electrode of the second switching component is a base electrode of the transistor, the second electrode of the second switching component is a collector of the transistor, the third electrode of the second switching component is an emitter of the transistor.

10. The relay switching circuit as claimed in claim 8, wherein the second diode is used to provide a discharge circuit for the third control terminal and the fourth control terminal of the second switching circuit.

11. A communication device comprising:
an FXS port, used to connect to a telephone;
an FXO port, used to connect to a PSTN (Public Switched Telephone Network);
an FXS circuit, used to process analog signals;
an FXO circuit, used to process and transmit signals to the FXO port;
a relay switching circuit;
a controller, connected among the FXS circuit, the FXO circuit, and the relay switching circuit to provide an enable signal to the relay switching circuit;
a net port, used to connect to the PSTN; and
a front-end circuit, connected between the net port and the controller to process network signals;
wherein the relay switching circuit further comprises:
a first switching circuit, connecting to the FXS port and the FXS circuit to control a connection between the FXS port and the FXS circuit;
a second switching circuit, connecting to the first switching circuit and the FXO port to control a connection between the first switching circuit and the FXO port;
a first control circuit, connecting to the controller to receive the enable signal from the controller to control the first switching circuit; and
a second control circuit, connecting to the controller to receive the enable signal from the controller to control the second switching circuit.

12. The communication device as claimed in claim 11, wherein the first switching circuit comprises:
a first normally closed contact;
a second normally closed contact;
a first control terminal, connecting to the first control circuit;
a second control terminal, connecting to the first control circuit;
a first common contact, connecting to the FXS port;
a second common contact, connecting to the FXS port;
a first normally open contact, connecting to the FXS circuit; and
a second normally open contact, connecting to the FXS circuit.

13. The communication device as claimed in claim 12, wherein the first control circuit comprises:
a first resistor with a first end of the first resistor connects to the controller;
a second resistor, wherein one end of the second resistor connects to a second end of the first resistor and the other end of the second resistor connects to a ground;
a first capacitor, wherein one end of the first capacitor connects to a second end of the first resistor and the other end of the first capacitor connects to the ground;
a first switching component, wherein a first electrode of the first switching component connects to the second end of the first resistor, a second electrode of the first switching component connects to the first control terminal, a third electrode of the first switching component connects to the ground;
a first diode, wherein a positive electrode of the first diode connects to a second electrode of the first switching component, a negative electrode of the first diode connects to the second control terminal; and
a third resistor, wherein one end of the third resistor connects to the negative electrode of the first diode, the other end of the third resistor connects to a power supply.

14. The communication device as claimed in claim 13, wherein the first switching component is an NPN type transistor, the first electrode of the first switching component is a base electrode of the transistor, the second electrode of the first switching component is a collector of the transistor, the third electrode of the first switching component is an emitter of the transistor.

15. The communication device as claimed in claim 13, wherein the first diode is used to provide a discharge circuit for the first control terminal and the second control terminal of the first switching circuit.

16. The communication device as claimed in claim 12, wherein the second switching circuit comprises:
a third control terminal, connecting to the second control circuit;
a fourth control terminal, connecting to the second control circuit;
a third normally closed contact, connecting to the FXO port;
a fourth normally closed contact, connecting to the FXO port;
a third common contact, connecting to the first normally closed contact; and
a fourth common contact, connecting to the second normally closed contact.

17. The communication device as claimed in claim 16, wherein when the first switching circuit and the second switching circuit are not working, the first common contact connects to the first normally closed contact, the second common contact connects to the second normally closed contact, the third common contact connects to the third normally closed contact, the fourth common contact connects to the fourth normally closed contact; and
when the first switching circuit and the second switching circuit are working, the first common contact switches off the connection to the first normally closed contact and connects to the first normally open contact, the second common contact switches off the connection to the second normally closed contact and connects to the second normally open contact, the third common contact switches off the connection to the third normally closed contact and connects to the third normally open contact, the fourth common contact switches off the connection to the fourth normally closed contact and connects to the fourth normally open contact.

18. The communication device as claimed in claim 16, wherein the second control circuit comprises:
a fourth resistor, wherein a first end of the fourth resistor connects to the controller;
a fifth resistor, wherein one end of the fifth resistor connects to a second end of the fourth resistor and the other end of the fifth resistor connects to the ground;
a second capacitor, wherein one end of the second capacitor connects to a second end of the fourth resistor and the other end of the second capacitor connects to the ground;
a second switching component, wherein a first electrode of the second switching component connects to the second end of the fourth resistor, a second electrode of the second switching component connects to the third control terminal, a third electrode of the second switching component connects to the ground;
a second diode, wherein a positive electrode of the second diode connects to a second electrode of the second switching component, a negative electrode of the second diode connects to the fourth control terminal; and
a sixth resistor, wherein one end of the sixth resistor connects to the negative electrode of the second diode, the other end of the sixth resistor connects to the power supply.

19. The communication device as claimed in claim 18, wherein the second switching component is an NPN type transistor, the first electrode of the second switching component is a base electrode of the transistor, the second electrode of the second switching component is a collector of the transistor, the third electrode of the second switching component is an emitter of the transistor.

20. The communication device as claimed in claim 18, wherein the second diode is used to provide a discharge circuit for the third control terminal and the fourth control terminal of the second switching circuit.
